(19) United States
(12) Patent Application Publication
(10) Pub. No.: US 2026/0226973 A1
(43) Pub. Date: Aug. 6, 2026

(54) GEAR, METHOD FOR PRODUCING A GEAR AND USE OF SUCH A GEAR

(71) Applicant: SMS Group GmbH, Mönchengladbach (DE)

(72) Inventors: Thomas DASTIG, Leverkusen (DE); Stefan WARDER, Viersen (DE)

(21) Appl. No.: 19/128,903

(22) PCT Filed: Nov. 8, 2023
(86) PCT No.: PCT/EP2023/081114

§ 371 Date: May 9, 2025

(30) Foreign Application Priority Data
Nov. 11, 2022 (DE) 10 2022 129 867.1

(51) Int. Cl. F16H 55/12; F16H 55/06; F16H 55/17

(52) U.S. Cl. CPC F16H 55/12; F16H 55/06; F16H 55/17

(57) ABSTRACT

A gear, having a reference diameter of greater than or equal to 1.5 m, with a gear hub and a gear rim, wherein the gear hub and gear rim are releasably connected to one another, and that the gear hub includes a plurality of elements that are welded together.

The invention relates to a gear with a reference diameter of greater than or equal to 1.5 m.

The invention further relates to a method for producing a gear with a reference diameter of greater than or equal to 1.5 m.

The invention also relates to a use of a gear.

Gears of this type are known from the prior art. As a rule, gears of this size are made as cast parts with a toothing machined on the circumference.

The object of the invention is that of providing an improvement over or an alternative to the prior art.

The underlying object of the present invention is achieved by a gear having the features of claim 1. Advantageous embodiments of the gear are described in the claims dependent on claim 1.

More specifically, according to a first aspect of the invention, the object is achieved by a gear with a reference diameter of greater than or equal to 1.5 m and a gear hub and a gear rim, wherein the gear is characterized in that the gear hub and the gear rim are releasably connected to one another, and the gear hub consists of a plurality of elements welded together.

In other words, a two-part gear is proposed here, the gear hub of which is based on a welded construction.

The inventive design of the present gear enables particularly cost-effective production of even larger gears with a reference diameter of 1.5 m or larger.

This is in particular advantageous with regard to the manufacturing costs and, in particular, the operating costs of a press and/or punching device, such as a drop forge or similar, since these can also be significantly reduced.

In particular, gears of this type are generally exposed to high levels of manpower in such press and/or punching devices, which on the one hand significantly reduces their operating times with regard to external circumferential toothing, and/or on the other hand often causes irreparable damage to their external circumferential toothing due to critical load peaks.

In particular, critical load peaks often occur in press and/or punching devices in the form of shock loads in connection with pressing and/or punching operations and ultimately affect the gears of the drives of such press and/or punching devices.

Furthermore, gears dimensioned in this way usually have larger tolerances with regard to their outer circumferential toothing, in particular tolerances in the shape of the toothing of several tenths of a millimeter.

However, the present separately manufactured gear rims can be manufactured with significantly smaller tolerances, which means that load peaks can be further advantageously reduced or better absorbed due to the resulting lower backlash compared to counter gears.

The gear according to the invention can therefore be used particularly advantageously in particular in a press and/or punching device in order to be able to use the effects and advantages explained here also on such a press and/or punching device.

Therefore according to a further aspect of the invention, the invention also relates to a press and/or punching device for pressing or punching, in particular, metal semi-finished products and/or semi-finished products made of non-ferrous metals, such as slabs, billets, forging blanks or the like, with a drive device and a ram part driven thereby, wherein the press and/or punching device is specifically distinguished by a gear according to one of the features described herein.

It is understood that the present invention can be applied particularly advantageously to gears with reference diameters greater than or equal to 2.0 m, 2.5 m, 2.8 m and 3 m. Furthermore, the gear preferably has a reference diameter of greater than or equal to 3.5 m, preferably greater than or equal to 4.0 m and particularly preferably greater than or equal to 4.5 m. Likewise preferably, the gear has a reference diameter of greater than or equal to 5.0 m, furthermore preferably a reference diameter of greater than or equal to 5.5 m, preferably greater than or equal to 6.0 m, and particularly preferably greater than or equal to 6.5 m.

Gears of this type with such dimensioned reference diameters are often manufactured as one-piece cast constructions, with an outer circumferential toothing then being produced by means of machining.

The larger the reference diameter, the more casting material can be saved with the gear constructed according to the invention, which on the one hand can further reduce the manufacturing costs.

Preferably, the gear has a reference diameter of less than or equal to 7.0 m, further preferably a reference diameter of less than or equal to 6.0 m, preferably a reference diameter of less than or equal to 5.0 m, and particularly preferably a reference diameter of less than or equal to 4.0 m or less, or a reference diameter of less than or equal to 3.0 m.

On the other hand, the gear design proposed in the present case, in particular with regard to the welded design of the gear hub, can reduce the overall CO₂ emissions of the gear associated with production. This saving of CO₂ emissions can be advantageously further increased if the complete replacement of an entire gear can be dispensed with and, if necessary, only the gear rim needs to be replaced, for example over the life cycle of a press and/or punching device.

In addition, the present welded construction is less prone to defects than cast constructions which are often unusable or have to be repaired at great expense due to critical defects such as unwanted material inclusions, blowholes or similar in the cast material.

Furthermore, it is advantageous in the present case that a cost-effective and/or readily available material can be used for the gear hub than is required for the gear rim, in particular with lower material properties. This is usually not possible with a cast construction since the hub as well and not just the toothing is made of a uniform material, wherein the material requirements for the entire gear are usually determined by the gear rim. For example, in this case it is not absolutely necessary for the gear hub to be made of heat-treated steel.

Within the meaning of the invention, the term “gear hub” describes any structural areas of the gear or components thereof which are arranged substantially radially further inward of the gear rim. In this case, the gear hub is at any rate designed as a separate component of the gear with respect to the gear rim and is therefore firmly but releasably arranged on the gear rim.

The gear hub can be designed in different ways, although only initial possibilities for the design of the gear hub are given here as examples.

For example, the gear hub can have different bearing seats on its inner diameter. It is possible, for example, that the gear hub has, in particular, two mutually corresponding bearing seats which are designed to realize an adjusted bearing.

Alternatively, the gear hub can also have a fixed shaft-hub connection which in turn can be designed in particular as a cylindrical interference fit and/or conical interference fit. Furthermore, the gear hub can also be provided for a form-fitting shaft-hub connection, in particular for a connection by means of a feather key, cylindrical pin, wedge, expansion dowel connection and/or the like.

The term “gear rim” in the present case describes an annular component of the gear according to the invention, which is arranged firmly but releasably as a separate component substantially radially further outward on the gear hub.

Preferably, the gear rim is designed as a closed, circumferential ring component which, among other things, can significantly improve the dimensional stability of the gear rim.

In any case, the gear hub and the gear rim are firmly but releasably connected to each other. This makes it possible to repair the gear in a cost-effective manner, for example by removing a worn or damaged gear rim from the gear hub and replacing it with a new or reconditioned gear rim.

In other words, this means that the gear hub and the gear rim have a reversible connection to each other. This makes it not only easy to structurally join the gear hub and the gear rim together, but also to separate them again from each other.

Preferably, the gear hub and the gear rim can be separated from each other without causing any damage so that the gear hub and/or the gear rim can be reused in case of doubt, for example after a repair, maintenance and/or modernization.

In this respect, it is advantageous if the gear has a connecting device by means of which the gear hub and the gear rim can be firmly but releasably connected to one another.

Preferably, this connecting device is different from a material connection between the gear hub and the gear rim, which significantly increases the chances of a non-destructive removal of the connection between the gear hub and the gear rim.

Frictional or force-locking connections as well as form-fitting connections are advantageous here since within the meaning of the invention they can, on the one hand, act well between the gear hub and the gear rim and, on the other hand, can also be easily released again.

The connecting device in this case can be constructed in different ways. Preferably, the connecting device comprises a plurality of connecting elements which enable a reversible connection between the gear hub and the gear rim.

It is advantageous if the connecting elements can be removed without causing any damage. This allows for a quick separation of the gear hub and gear rim.

Ideally, the connecting elements can be at least partially reused, which can further reduce costs.

The following terms should also be explained:
It is expressly noted that, in the context of the present patent application, indefinite articles and numbers such as “one,” “two,” etc., should generally be understood as being “at least” statements, i.e., as “at least one . . . ,” “at least two . . . ,” etc., unless it is clear from the relevant context or it is obvious or technically compelling to a person skilled in the art that only “exactly one . . .,” “exactly two . . . ,” etc., can be meant.

In the context of the present patent application, the expression “in particular” should always be understood as introducing an optional, preferred feature. The expression should not be understood to mean “specifically” or “namely.”

It is particularly advantageous that the present gear can be constructed modularly due to the designed separation of the gear hub and gear rim.

For example, it is possible to equip the gear hub with differently designed gear rims. In this respect, identical or similarly designed gear hubs can be manufactured industrially in a first production step and, in a further production step, equipped or connected with a gear rim which carries a desired or required toothing.

On the other hand, it is possible to choose differently designed gear hubs for the same gear rims, which can achieve additional scalability.

Furthermore, it is expedient if the gear rim has a herringbone toothing or a double helical toothing or a straight toothing.

A herringbone toothing, for example, in this case promotes particularly smooth running and/or self-centering with regard to intermeshing tooth elements. In this respect, it is in particular advantageous in connection with a press and/or punching device if the gear rim has a herringbone toothing.

A double helical toothing, for example, is cheaper to produce and also has a self-centering effect. Such a double helical toothing can be more or less regarded as a two-part toothing or a herringbone toothing in which the “apex of the V” is missing.

A straight toothing for example is even cheaper to produce.

In any case, with regard to the gear in question, the gear hub can easily be equipped with a wide variety of gear rims which in turn are characterized by different toothings.

A favorable embodiment provides that the elements of the gear hub comprise a structural steel according to DIN EN 10025, preferably an S235 structural steel and particularly preferably an S355 structural steel, in particular a fine-grained structural steel according to DIN EN 10025, preferably an S460.

A structural steel according to DIN EN 10025 is particularly inexpensive, and therefore the manufacturing costs of the gear, in particular the gear hub, can be further reduced.

Preferably, the gear hub is made of S235 structural steel, at least predominantly. As a rule, S235 structural steel is very readily available and still relatively inexpensive to purchase.

Particularly preferably, the gear hub is made of S355 structural steel, at least predominantly. In addition to good availability, S355 structural steel has more advantageous material properties which can have a positive effect on the use of this gear.

Fine-grained structural steels can also be advantageously used to manufacture the gear hub. For example, a fine-grained structural steel according to DIN EN 10025 has good welding properties. Preferably, a fine-grained structural steel of grade S460 can be used here, since this fine-grained structural steel is also readily available.

It goes without saying that other materials are also suitable for the production of this gear hub. For example, a heat-treated steel 25CrNiMo6 has very good strength and is still easy to weld.

It goes without saying that the gear rim can also be made from a wide variety of materials.

It is also particularly useful if the gear rim is made of a heat-treated steel in accordance with DIN EN 10083, or of a case-hardened steel in accordance with DIN EN 10084, or of a nitriding steel in accordance with DIN EN 10085.

If the gear rim is made of a heat-treated steel according to DIN EN 10083, the gear rim can be characterized by good strength.

Using a case-hardened steel according to DIN EN 10084, the gear rim can be given improved wear resistance.

An even further improved surface hardness can be achieved on the gear rim with a nitriding steel according to DIN EN 10085.

As a rule, components made of case-hardened steels or nitriding steels are also distinguished by a tougher “component core” and a harder “component surface”.

In addition it is advantageous if the gear rim has a chromium content of greater than or equal to 1.05%, preferably a chromium content of greater than or equal to 1.1%, and particularly preferably a chromium content of greater than or equal to 1.3%.

Chromium content in a steel material results in chromium carbides, which in turn result in greater hardness, which on the one hand can yield improved wear resistance and on the other hand a higher temperature resistance.

A gear rim with a chromium content of greater than or equal to 1.05% can, for example, be realized using the material 25CrMo4.

Whereas a gear rim with a chromium content of greater than or equal to 1.1% can be realized using the material 42CrMo4.

For example, using the material 34CrNiMo6, a chromium content of greater than or equal to 1.3% can be achieved on the gear rim, which gives the gear rim, for example, very good surface strength.

Further improved material properties can be achieved on the gear rim if the gear rim has a manganese content of greater than or equal to 0.5%, preferably a manganese content of greater than or equal to 0.7%, and particularly preferably a manganese content of greater than or equal to 0.75%.

The alloying component manganese not only improves forgeability, but also weldability, general strength and wear resistance. In addition, the alloying component manganese reduces the tendency of a correspondingly alloyed steel to red fracture.

Good weldability is in particular advantageous for repair welding.

For example, using the material 34CrNIMo6, a gear rim with a manganese content of greater than or equal to 0.5% can be provided.

A manganese content of greater than or equal to 0.7% in the gear rim can be achieved with the material 25CrMo4.

A manganese content of greater than or equal to 0.77% in the gear rim can, for example, be achieved with the material 42CrMo4.

In any case, the gear hub and the gear rim of the present gear can easily be made of different materials.

In particular, it is advantageous if the material of the gear hub and the gear rim can be selected depending on the component function or component load to be fulfilled.

The gear, in particular its gear hub, can advantageously be connected to other components if the gear hub has a coupling receptacle, in particular a coupling receptacle designed as a turned flat surface, wherein the coupling seat preferably has a bolt circle.

If the gear hub has a coupling seat designed as a turned flat surface, the gear as a whole can be equipped with a particularly precise seating surface.

If the coupling seat also has a bolt circle, the coupling seat can be advantageously arranged on the other components of the gear hub.

It is advantageous in this regard if, as a rule, a cast clutch housing can be screwed on, wherein, for example, a counter surface for a friction pair of a clutch is then formed in the clutch housing.

The friction pair is usually designed radially symmetrical.

Alternatively, however, a turned surface can also be provided, which can form a corresponding friction pair directly with a clutch disk.

Furthermore, it is advantageous if the gear hub has at least one flank with a material thickness of greater than or equal to 15 mm, preferably greater than or equal to 20 mm, particularly preferably greater than or equal to 30 mm. The gear hub preferably has at least one flank with a material thickness greater than or equal to 25 mm, preferably a material thickness greater than or equal to 35 mm, and particularly preferably a material thickness greater than or equal to 45 mm.

Alternatively, a gear hub is also possible as a single-stage, thick-walled sheet steel design with a protruding wall thickness of one flank, wherein a main body does not have a box-shaped design but consists of only one flank.

As a rule, a main body of the gear hub is welded as a box. In other words, the gear hub preferably has a box-like welded frame part.

The gear hub produced in this way can in this case have a first and a second disk-shaped flank as well as internal ribs for connecting these flanks.

A first, thicker flank of the flanks can in this case serve as a contact surface for a clutch housing or, for example, for a direct clutch friction pair.

A second flank (usually the thinner flank) of the flanks may also typically have circular holes or other shaped recesses through which access to the box interior is provided, for example for creating the welds.

If the gear rim is shrunk onto the gear hub, a structurally simple frictional connection between the gear rim and the gear hub can be created.

Such an interference fit offers an extremely robust solution for attaching the gear rim to the gear hub.

In this way, for example, any distortion of the gear rim, in particular a tilting of one side of the gear rim, can be counteracted, in particular by a rigidity emanating from the gear hub in this area.

Furthermore, a connection between the gear hub and the gear rim can be realized even more stably if the gear hub and the gear rim are connected to each other by means of at least one fitting bolt, preferably with at least three fitting bolts and particularly preferably with at least five fitting bolts.

Preferably, the connection between the gear rim and the gear hub has more than or equal to seven fitting bolts, preferably more than or equal to 11 fitting bolts, and particularly preferably more than or equal to 15 fitting bolts.

The term “fitting bolt” within the meaning of the invention describes an elongate bolt element with both a relatively thick and a relatively short body. Generic fitting bolts are often also referred to as fitting pins or the like.

In this case, the fitting bolt preferably has a suitably large cross-sectional area so that the fitting bolt has a reliable shear resistance as a result. Furthermore, it is advantageous in this context if the at least one fitting bolt generates only a low surface pressure, even when high forces and/or torques are to be transmitted.

With regard to the fitting bolts, cross-sectional areas with values greater than or equal to 314.16 mm² (r=10 mm) are advantageous, preferably greater than or equal to 706.86 mm² (r=15 mm) or particularly preferably greater than or equal to 1256.64 mm² (r=20 mm). By means of cross-sectional areas selected in this way, sufficiently dimensioned fitting bolts can be provided along the circumferential direction of the gear, which can ensure sufficient anti-twist protection between the gear hub and the gear rim.

Preferably, a fitting bolt has a cross-sectional area of greater than or equal to 1963.50 mm² (r=25 mm), preferably greater than or equal to 2827.43 mm² (r=30 mm), and particularly preferably greater than or equal to 3848.46 mm² (r=35 mm).

A sufficiently high number of fitting bolts can still be provided in the circumferential direction on the gear if the fitting bolts have for example cross-sectional areas with values of less than or equal to 3848.46 mm² (r=35 mm), preferably less than or equal to 2827.43 mm² (r=30 mm) or particularly preferably less than or equal to 1963.50 mm² (r=25 mm).

Fitting bolts of this type are known from the prior art and are therefore not described in more detail here with regard to their structural design and their function.

The gear rim can be particularly well fixed to the gear hub if the gear rim has a shoulder in an inwardly directed region, wherein the gear hub and the gear rim are connected to one another in operative connection with the shoulder by means of at least one expansion screw, preferably with at least three expansion screws and particularly preferably with at least five expansion screws.

Preferably, the connection between the gear rim and the gear hub has more than or equal to seven expansion screws, preferably more than or equal to 11 expansion screws and particularly preferably more than or equal to 15 expansion screws.

Advantageously, the radially inwardly extending shoulder can serve as a support for a screw head of the at least one expansion screw and/or to provide an internal thread and thus to receive an external thread of the expansion screw.

For example, this also makes it possible to easily absorb axial forces between the gear rim and the gear hub. In particular, a high preload force for the screw connection can be achieved by means of an expansion screw. This ensures that axial operating forces only exert a smaller additional load on the expansion screw connection. In particular, the high preload force which is made possible by means of expansion screws means that a larger part of the axially occurring loads is already absorbed by the components involved and does not have to be absorbed largely by the screw connection.

Expansion screws of this type are known from the prior art and are therefore not described further here with regard to their structural design and function.

An expansion screw used here as a connecting means has a comparatively long and slender screw area which extends threadlessly between a screw head and a screw thread base, whereby a particularly high preload force of the connecting means can be achieved.

A high preload force advantageously leads to a robust connection between the shoulder and the gear hub on the one hand and to a low tendency to loosen on the other.

In any case, it should be explicitly emphasized again at this point that a combination of different connecting means or connecting elements is advantageous since each connecting means or connecting element has its own advantages. In particular, appropriate connecting means constellations are advantageous.

By means of a cylindrical interference fit, for example, a large-area radially acting frictional or force-locking connection can advantageously be provided over the entire circumferential surface of the gear hub, whereby a good anti-twist protection can be ensured with regard to the gear rim and the gear hub.

A cylindrical interference fit between the gear hub and the gear rim can be joined and/or loosened by a temperature difference between the gear hub and the gear rim, so that a cylindrical interference fit is also considered a releasable connection within the scope of this aspect.

Alternatively, in order to release a cylindrical interference fit between the gear hub and the gear rim, one or more channels can be provided in the gear hub, in particular bores which extend in the direction of the connecting surface between the gear hub and the gear rim and which are designed to exert a radial force on the gear rim by means of a fluid pressure in the channel so that it can be released from the gear hub.

Furthermore, a form-fitting connection can be advantageously provided between the gear rim and the gear hub by means of fitting bolts. This allows load peaks acting on the gear rim in particular to be well absorbed and introduced into the gear hub, which also can prevent the risk of a frictional or force-locking connection established between the gear rim and the gear hub being overcome and/or slipping due to critical load peaks.

Using expansion screws, the gear rim and the gear hub can be clamped axially together in a more targeted manner.

Overall, an advantageous connecting device can be realized on the present gear by means of various, ideally supplementary connecting means.

A further advantageous embodiment variant provides that the gear has an acceleration sensor.

If such an acceleration sensor is set up to detect operating vibrations of the gear, the function or condition of the gear can be advantageously monitored during operation, quasi “on-the-fly”, in particular during the operation of press and/or punching devices.

Ideally, an inspection of the toothing condition can be carried out cost-effectively using commercially available sensors, in particular during a maintenance run with the gear in the assembled state, for example with regard to a press and/or punching device.

In particular, a frequency density spectrum of the acceleration sensor signal makes it possible to detect whether there is damage to the gear or whether a connecting means or a connecting element is no longer functioning properly, in particular via a corresponding peak in the frequency density spectrum and/or a change in an eigenmode of the gear.

The object forming the basis of the present invention is also achieved by a method for a gear having the features of claim 13. Advantageous embodiments of the method are described in the claims dependent on claim 13.

More specifically, the object is achieved according to a second aspect of the invention by a method for producing a gear with a reference diameter of greater than or equal to 1.5 m, with a gear hub and with a gear rim, in which the gear hub is produced by means of a welded construction, in which the gear rim is produced by means of a closed circumferential ring part, and in which the gear hub and the gear rim are subsequently firmly but releasably connected to one another by means of a force-locking or friction connection and/or by means of a fitting bolt connection and/or by means of an expansion screw connection.

By means of such a method, gears of considerable size or with considerably large reference diameters can be manufactured particularly easily and inexpensively, as already explained multiple times above.

It is particularly advantageous if suitable fitting bolt connections and/or expansion screw connections are arranged between an external toothing of the gear and a friction or force-locking connection, whereby the firm but releasable connection between the gear hub and the gear rim can be realized particularly compactly on the gear.

In this respect, a preferred method variant provides that bores are made in the gear for the fitting bolt connection and/or for the expansion screw connection between the reference circle of the gear and the frictional or force-locking connection.

At this point, it should also be claimed that the described method can also be supplemented by further technical features described here, in particular by features of the device, in order to advantageously further develop it or to be able to represent or formulate method specifications even more precisely.

The object forming the basis of the present invention is also achieved by a use of a gear having the features of claim 15.

More specifically, the object is achieved according to a third aspect of the invention by using a gear according to one of the features described herein.

In particular, the use of the proposed gear in conjunction with press and/or punching devices is extremely advantageous since it can significantly reduce operating and maintenance costs.

Furthermore, the use of the present gear as a replacement part or spare part is particularly advantageous since the gear according to the invention represents an extremely cost-effective alternative to an original gear of a processing machine, such as press and/or punching devices for processing metal semi-finished products and/or semi-finished products made of non-ferrous metals, in particular for gears with a reference diameter of greater than or equal to 1.5 m and particularly with even larger reference diameters, such as 4 m or 5 m.

Furthermore, according to a further aspect of the invention, the use of a gear rim, in particular in the form of a closed ring part for producing the gear on which the invention is based, in particular on a multi-part gear with a reference diameter of greater than or equal to 1.5 m, is also advantageous since this allows particularly large gears to be produced more cheaply than before, but still more robustly.

The advantage of the circumferentially closed ring part is, among other things, that the gear rim can thereby be positioned much more precisely on the gear hub than, for example, a band-shaped toothing which is placed circumferentially around the gear hub.

It should be expressly noted that the subject matter of the respective aspects of the invention can advantageously be combined, specifically individually or cumulatively in any combination.

Further advantages, details, and features of the invention can be found below in the described exemplary embodiments. In the figures, in detail:

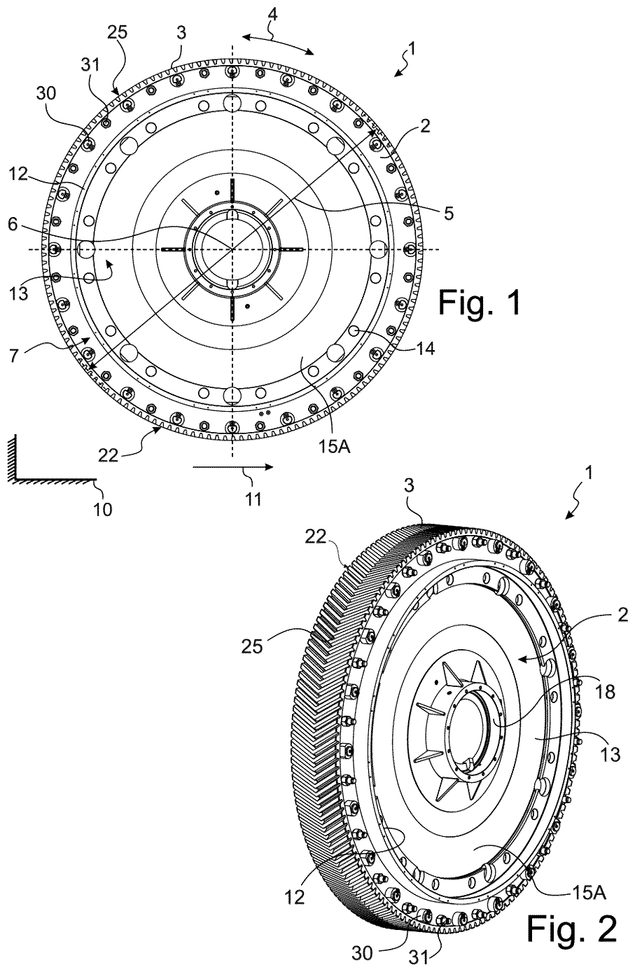

FIG. 1: schematically shows a front view of a gear with a gear hub and with a gear rim, wherein the gear hub and the gear rim are firmly but releasably connected to one another;

FIG. 2: schematically shows a first perspective view of the gear shown in FIG. 1;

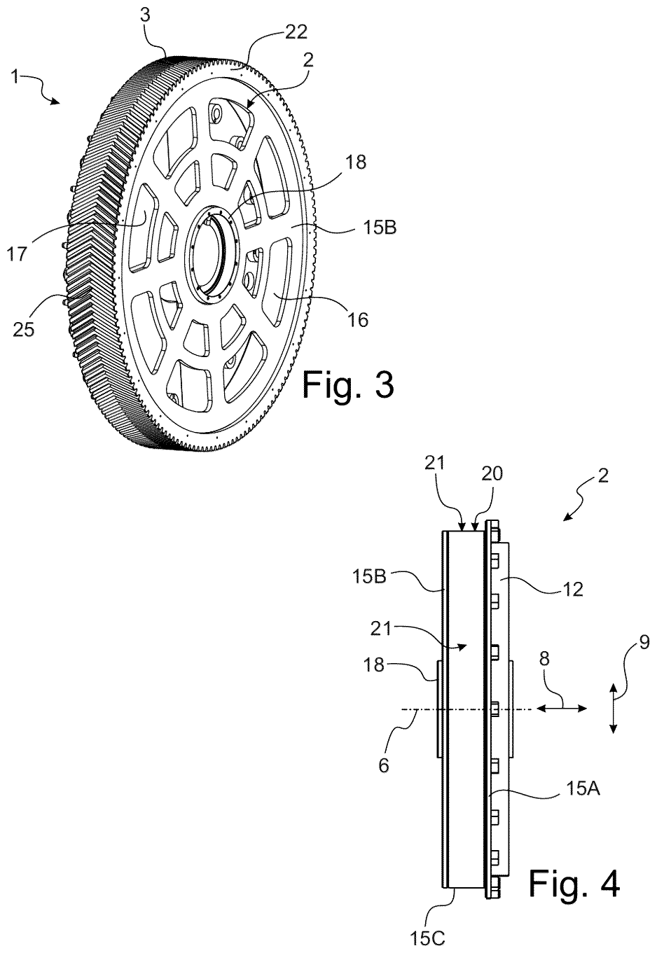

FIG. 3: schematically shows another perspective view of the gear shown in FIGS. 1 and 2;

FIG. 4: schematically shows a side view of the gear hub of the gear shown in FIGS. 1 to 3 without a gear rim;

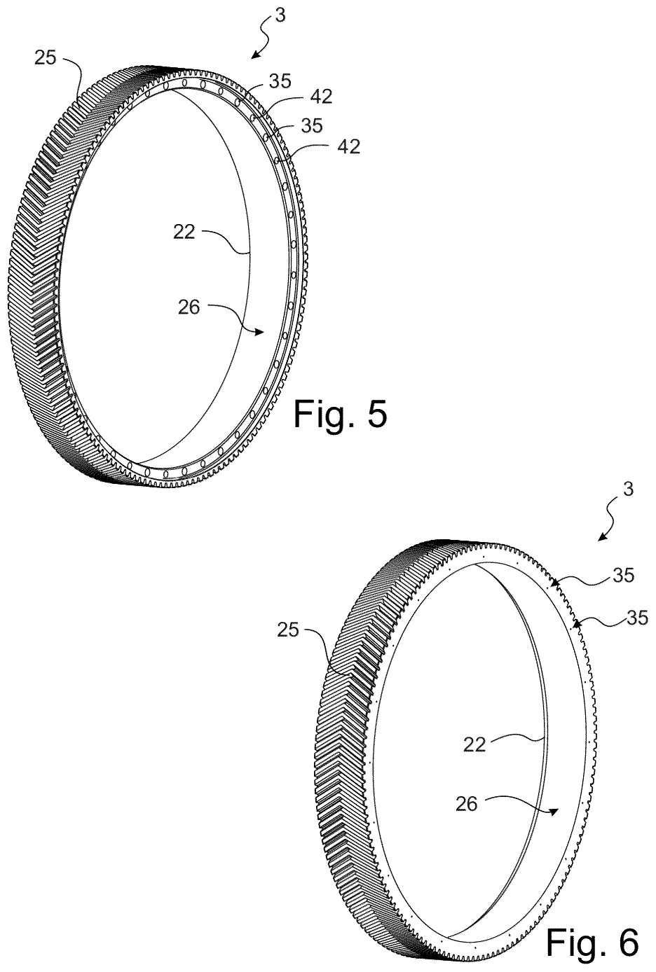

FIG. 5: schematically shows a first perspective view of the gear rim of the gear shown in FIGS. 1 to 3 without a gear hub;

FIG. 6: schematically shows a further perspective view of the gear rim shown in FIG. 5;

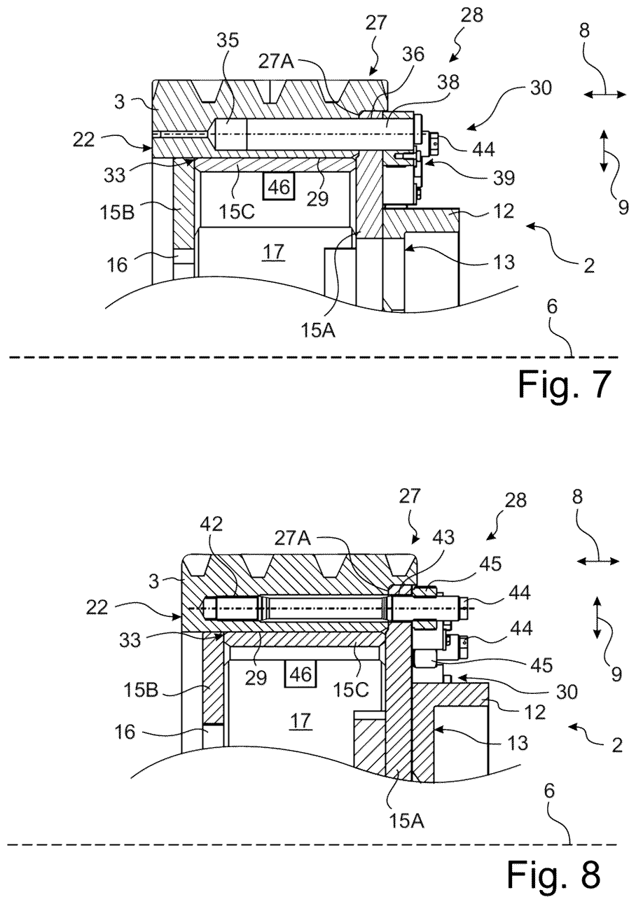

FIG. 7: schematically shows a partial sectional view of a fitting bolt connection of a releasable connecting device of the gear shown in FIGS. 1 to 3; and

FIG. 8: schematically shows a partial sectional view of an expansion screw connection of a releasable connecting device of the gear shown in FIGS. 1 to 3.

In the following description, the same reference signs denote the same components or features; in the interest of avoiding repetition, a description of a component made with reference to one drawing also applies to the other drawings. Furthermore, individual features that have been described in connection with one embodiment can also be used separately in other embodiments.

The gear 1 shown as a whole in FIGS. 1 to 3 has a gear hub 2 (see in particular also FIG. 4) and a gear rim 3 (see in particular also FIGS. 5 and 6), which are releasably but firmly connected to one another.

In this exemplary embodiment, the gear 1 is also distinguished by a reference diameter 5 of 2 m running in the circumferential direction 4 of the gear 1.

The gear 1 also has a rotation axis 6 around which the gear 1 rotates when used properly.

As can be clearly seen in particular according to the illustration in FIG. 4, the gear 1 has an axial extension in the axial direction 8 and a radial extension in the radial directions 9.

The gear 1 is designed as a cost-effective replacement or exchange part for often very expensive original gears, but it can also be used by the manufacturer as an original equipment part in a brand-new processing machine.

Furthermore, the gear hub 2 is designed as a welded construction and comprises a plurality of elements 7 welded together (only generally numbered here), as will be explained in more detail later.

In this exemplary embodiment, the gear hub 2 is made of a fine-grained structural steel of grade S460 in terms of its welded construction, while the gear rim 3 is made of 42CrMo4.

It is understood that depending on the field of use of the gear 1, the materials of the gear hub 2 and gear rim 3 can be selected individually.

Because in the assembled state the gear hub 2 and the gear rim 3 are firmly connected to one another on the one hand, and in this case in their entirety form the gear 1, and the gear hub 2 and the gear rim 3 are also releasable from one another on the other hand, the gear hub 2 and the gear rim 3 can be manufactured very well in a functionally optimized manner, be it with regard to the most favorable material selection or the most favorable manufacturing method or the most favorable manufacturing processing, or similar.

In this respect, the gear 1 is distinguished by a modular design, wherein the gear hub 2 and gear rim 3 can be selected and assembled depending on the designated field of application of the gear 1.

In this exemplary embodiment, the gear hub 2 and the gear rim 3 are designed for use in a forging press 10 (not shown further here) and are accordingly optimized in such a way that, on the one hand, the gear rim 3 can in particular withstand shock loads and, on the other hand, the gear hub 2 is reusable should the gear rim 3 need to be replaced due to wear or damage caused by stress.

The forging press 10 is in turn integrated as a processing station (not numbered again here) in a forging line 11 for processing metal semi-finished products and/or semi-finished products made of non-ferrous metals, in particular forging blanks.

In other words, the gear 1 is a component of the forging press 10 of a forging line 11. In this respect, the gear 1 belongs to a rolling mill (not shown here).

Furthermore, the gear hub 2 in this exemplary embodiment is also distinguished by a coupling seat 12 with a turned flat surface 13 in order to compensate for any signs of distortion caused by welding processes during the production of the gear hub 2. In this respect, attachments not shown here, such as a clutch housing (not shown) or the like, can be attached to the gear hub 2 with a precise fit by means of the coupling seat 12.

The coupling seat 12 also has a bolt circle 14, by means of which the coupling seat 12 itself can be fastened to the gear hub 2.

As a welded construction, the gear hub 2 has a frame part 15 welded in a box-like manner, wherein it can be clearly seen, in particular according to the illustrations in FIGS. 7 and 8, that the frame part 15 welded in a box-like manner has at least a first disk-shaped flank element 15A and a second disk-shaped flank element 15B which are welded together by means of rib elements 15C located therebetween, wherein in this case (FIGS. 7 and 8), only a radially further outwardly located rib element 15C can be seen which is designed as a ring element 15C at this outer position.

Here, the coupling seat 12 described above is attached to the first disk-shaped flank element 15A, whereas the second disk-shaped flank element 15B primarily serves only to further stiffen the frame part 15 welded in a box-like manner and thus also the gear hub 2 as a whole.

In this respect, the second disk-shaped flank element 15B also only has a smaller component thickness (not explicitly specified) of 25 mm, while the first disk-shaped flank element 15A has a greater component thickness (also not explicitly numbered) of 45 mm.

Furthermore, the second disk-shaped flank element 15B has a plurality of recesses 16 which allow good access to the frame or box interior 17 of the gear hub 2 in order to be able to carry out high-quality welding work there as well.

Further radially inward, the gear hub 2 also has a bearing shell part 18 for supporting a shaft part (not shown) so that the gear 1 can rotate about the axis of rotation 6.

As can be clearly seen in particular from the illustration in FIG. 4, the gear hub 2 has a radial outer circumferential surface 20 further radially outwards, which is designed as a frictional contact outer surface 21 for supporting the gear rim 3.

The radial outer circumferential surface 20 in its entirety is formed in this case by the welded elements 7 “first and second disk-shaped flank element 15A and 15B” and “rib or ring element 15C”, while the frictional contact outer surface 21 in this exemplary embodiment is provided only by the second disk-shaped flank element 15B and the rib or ring element 15C.

As can be seen particularly clearly from the illustrations in FIGS. 5 and 6, the gear rim 3 has a circumferentially closed ring part 22 which is designed here as a shrink ring (not separately numbered again).

In this exemplary embodiment, the gear ring 3 has a herringbone toothing 25 which is arranged on the radially outer surface of the gear ring 3.

Located radially further inward, the gear rim 3 has an inner frictional contact surface 26, by means of which the gear rim 3 forms a frictional connection with the outer frictional contact surface 21 of the gear hub 2.

The gear rim 3 has a shoulder 27 which is arranged radially further inward with respect to the herringbone toothing 25 and which extends in the circumferential direction 4 of the gear 1.

The shoulder 27 in this case substantially has a vertically extending contact surface 27A in the form of an inwardly directed region (not numbered again) for axial contact of the first disk-shaped flank part 15A.

The gear 1 has a multi-acting connecting device 28 to releasably but firmly connect the gear hub 2 and the gear rim 3.

In this exemplary embodiment, the multi-acting connecting device 28 comprises a frictional or force-locking connection 29 (see in particular FIGS. 7 and 8), a fitting bolt connection 30 (see in particular FIG. 7) and an expansion screw connection 31 (see in particular FIG. 8), wherein the three connections 29, 30 and 31 can alternatively also be combined with one another differently, depending on the intended use or load bearing capacity for which the gear 1 is to be used.

The frictional or force-locking connection 29 is distinguished in particular by a press-shrink fit 33 comprising the frictional contact outer surface 21 on the gear hub 2 on the one hand and the frictional contact inner surface 26 of the gear rim 3 on the other hand.

According to the illustration in FIG. 7, the fitting bolt connection 30 can be clearly seen. The fitting bolt connection 30 substantially comprises a blind hole 35 extending in the axial direction 8 into the gear rim 3, a through-hole 36 extending in the axial direction 8 through the first disk-shaped flank element 15A, a fitting bolt 38 seated therein, and a fitting bolt loss prevention device 39.

According to the illustration in FIG. 8, the expansion screw connection 31 can be clearly seen. The expansion screw connection 31 substantially comprises a threaded blind hole 42 extending in the axial direction 8 into the gear rim 3, a threaded through-hole 43 extending in the axial direction 8 through the first disk-shaped flank element 15A, an expansion screw 44 screwed therein, and a lock nut part 45.

As can be clearly seen in particular from the illustrations in FIGS. 1 and 2, fitting bolt connections 30 and expansion screw connections 31 are arranged alternatingly on the gear 1 along the circumferential direction 4.

Here, both the fitting bolt connections 30 and the expansion screw connections 31 are arranged between the toothing or the herringbone toothing 25 and the frictional or force-locking connection 29, whereby a particularly compact connection device 28 is realized on the gear 1.

The fitting bolt connections 30 as well as the expansion screw connections 31 are arranged radially further outwards than the frictional or force-locking connection 29 on the gear 1.

Furthermore, the gear 1 also has at least one acceleration sensor 46 in order to be able to detect signs of wear or damage to the gear rim 3, in particular to the herringbone toothing 25, at an early stage, before signs of wear or damage prove to be critical.

### LIST OF REFERENCE SIGNS

1 gear
2 gear hub
3 gear rim
4 circumferential direction
5 reference diameter
6 axis of rotation
7 welded elements
8 axial direction
9 radial directions
10 forging press
11 forging line
12 coupling seat
13 flat surface
14 bolt circle
15 frame part welded in a box-like manner
15A first disk-shaped flank element
15B second disk-shaped flank element
15C rib or ring element
16 recesses or holes
17 frame or box interior
18 bearing shell part
20 radial outer circumferential surface
21 friction contact outer surface
22 circumferentially closed ring part
25 herringbone toothing
26 friction contact inner surface
27 shoulder or inwardly directed region
27A contact surface
28 connecting device
29 frictional or force-locking connection
30 fitting bolt connection
31 expansion screw connection
33 press-shrink fit
35 blind hole
36 through-hole
38 fitting bolt
39 fitting bolt loss prevention device
42 threaded blind hole
43 threaded through-hole
45 lock nut part
46 acceleration sensor

1. A gear with a reference diameter of greater than or equal to 1.5 m, comprising:
a gear hub, and
a gear rim,
wherein
the gear hub and the gear rim are releasably connected to one another, wherein the gear hub comprises a plurality of elements welded together.

2. The gear according to claim 1, wherein the gear rim comprises a herringbone toothing, or a double helical toothing, or a straight toothing.

3. The gear according to one of claims 1, wherein the plurality of elements of the gear hub comprises a structural steel according to DIN EN 10025.

4. The gear according to claim 1, wherein the gear rim is made of a heat-treated steel according to DIN EN 10083, or of a case-hardened steel according to DIN EN 10084, or of a nitriding steel according to DIN EN 10085.

5. The gear according to claim 1, wherein the gear rim has a chromium content of greater than or equal to 1.05%.

6. The gear according to claim 1, wherein the gear rim has a manganese content of greater than or equal to 0.5%.

7. The gear according to claim 1, wherein the gear hub comprises a coupling seat designed as a turned flat surface, wherein the coupling seat comprises a bolt circle.

8. The gear according to claim 1, wherein the gear hub comprises at least one flank with a material thickness of greater than or equal to 15 mm.

9. The gear according to claim 1, wherein the gear rim is shrunk onto the gear hub.

10. The gear according to claim 1, wherein the gear hub and the gear rim are connected to one another by means of at least one fitting bolt.

11. The gear according to claim 1, wherein the gear rim comprises a shoulder in an inwardly directed region, wherein the gear hub and the gear rim are connected to one another in operative connection with the shoulder by means of at least one expansion screw.

12. The gear according to claim 1, wherein the gear further comprises an acceleration sensor.

13. A method for producing a gear with a reference diameter of greater than or equal to 1.5 m, the gear comprising a gear hub and a gear rim, in which the gear hub is produced by means of a welded construction, in which the gear rim is produced by means of a closed circumferential ring part, and in which the gear hub and the gear rim are then firmly but releasably connected to one another by means of a force-locking connection and/or by means of a fitting bolt connection and/or by means of an expansion screw connection.

14. The method according to claim 13, wherein bores in the gear for the fitting bolt connection and/or for the expansion screw connection between the reference circle of the gear and the frictional or force-locking connection are introduced into the gear.

15. (canceled)
